(19) United States
(12) Patent Application Publication
(10) Pub. No.: US 2010/0018608 A1
(43) Pub. Date: Jan. 28, 2010

(54) Arm Arrangement For Supporting Coupler Section Carried At End Of Nurse Vehicle Fluid Transfer Conduit

(76) Inventors: Daniel Joseph Huegerich, Ankeny, IA (US); Travis Gene Funseth, Ankeny, IA (US); Tonya Marie O'neal, Davenport, IA (US); Richard Allen Humpal, Ankeny, IA (US)

Correspondence Address: DEERE & COMPANY, ONE JOHN DEERE PLACE, MOLINE, IL, 61265, US

(21) Appl. No.: 12/178,933

(22) Filed: Jul. 24, 2008

(51) Int. Cl. B67D 5/36

(52) U.S. Cl. 141/388; 137/572; 137/579; 137/581

(57) ABSTRACT

A sprayer nurse vehicle includes an arm arrangement which carries a coupler section that is connected to the discharge end of a fluid transfer conduit that extends from the nurse tank carried by the vehicle. The arm arrangement is constructed so that it may be extended outwardly from the nurse vehicle and moved vertically and laterally. An outer end of the arm arrangement is provided with a fluid coupler section mounting bracket that permits the coupler section to be swiveled about an upright axis and tilted about a transverse axis. A torsion bar is arranged along the transverse axis and is preloaded to counterbalance the weight of the hose and liquid contained therein so as to minimize the effort an operator must exert to tilt the fluid coupler section. The various movements of the arm arrangement and fluid coupler section mounting bracket permit the coupler section to be aligned with, and coupled to, a mating fluid coupler section carried by a sprayer vehicle when replenishing of the fluid carried by the sprayer tank is required.

### FIELD OF THE INVENTION

The present invention relates to structures for aiding in the connection of a first fluid coupler section carried at one end of a nurse tank vehicle fluid transfer conduit to a second fluid coupler section carried at an intake end of a sprayer vehicle fluid intake conduit during refill of a tank or tanks of the sprayer with fluid to be sprayed.

### BACKGROUND OF THE INVENTION

The process of applying liquid chemicals, such as fertilizers or herbicides, for example, to a field requires with a self-propelled or towed sprayer vehicle involves the step of refilling fluid tanks of the sprayer vehicle with fluids carried by a nurse tank vehicle. Due to the desire of keeping the re-fill time to a minimum, the fluid transfer conduit of the nurse vehicle and the fluid intake conduit of the sprayer vehicle are relatively large and respectively include relatively large first and second coupler sections that are selectively connected together to form a coupler assembly establishing a relatively large flow path between the transfer and intake conduits. The size of the transfer conduit and its associated coupler section results in them being relatively heavy and unwieldy for being handled manually as is sometimes done when connecting the coupler section of the transfer conduit to the coupler section of the intake conduit. Further, the transfer of fluid from the nurse tank vehicle to the sprayer vehicle must often take place on uneven terrain requiring the coupler section of the nurse vehicle be moved both vertically and angularly in order to align it with the coupler section carried at the end of the sprayer vehicle intake conduit.

The problem to be solved then is how to provide relatively large conduits for permitting quick transfer of fluid while making it relatively easy for an operator to manually effectuate the connection between the connector section of the fluid transfer conduit and the connector section of the fluid intake conduit.

### SUMMARY OF THE INVENTION

According to the present invention, there is provided a support arrangement for aiding the manual coupling of separable connector sections of a coupler arrangement used to connect a transfer conduit of a sprayer nurse vehicle to an intake conduit of a sprayer vehicle.

An object of the invention is to provide an arm arrangement for supporting a first coupler arrangement section, that is joined to an end of a nurse vehicle fluid transfer conduit, with the arm arrangement being constructed for permitting relatively easy manipulation of the first coupler section so that it may be aligned with a second coupler section of the coupler arrangement that is in a fixed location on a sprayer vehicle.

This object is achieved by an arm arrangement mounted to a support base, carried by the nurse vehicle, for swinging about a first upright axis, and including an elongate arm section mounted for pivoting vertically and carrying a swivel bracket at its outer end, with the swivel bracket being constructed for carrying a fluid coupler section so that the coupler section may be selectively swiveled about orthogonal upright and transverse axes. Further aspects of the object are achieved by constructing the elongate arm section in the form of a parallel linkage and providing by providing a counterbalancing arrangement for counterbalancing the combined suspended weight of the elongate arm section together with the fluid coupler section and accompanying fluid transfer conduit.

### BRIEF DESCRIPTION OF THE DRAWINGS

FIG. 1 is a schematic view of a sprayer vehicle positioned close to a nurse vehicle carrying an arm arrangement constructed according to the principles of the present invention and supporting a fluid coupler section in a position for being coupled to a mating fluid coupler section carried by the sprayer vehicle.

FIG. 2 is a left front perspective view of a portion of the nurse vehicle showing the arm arrangement in an extended condition and showing the fluid coupler section mounted to a bracket at an outer end of the arm arrangement, with the bracket being swiveled such that the fluid coupler section is approximately in fore-and-aft alignment with the parallel linkage section of the arm arrangement and with the fluid coupler section being tilted upwardly about its transverse pivotal connection with the bracket.

FIG. 3 is a right rear perspective view showing the arm arrangement in a folded, stored position.

FIG. 4 is a left side perspective view showing the arm arrangement in an intermediate position between the extended position of FIG. 2 and the folded position of FIG. 3.

FIG. 5 is a perspective view showing an outside of the connection between the swivel coupling and the torsion shaft at one side of the fluid coupler section.

FIG. 6 is a perspective view showing an inside of the connection shown in FIG. 5.

### DESCRIPTION OF THE PREFERRED EMBODIMENT

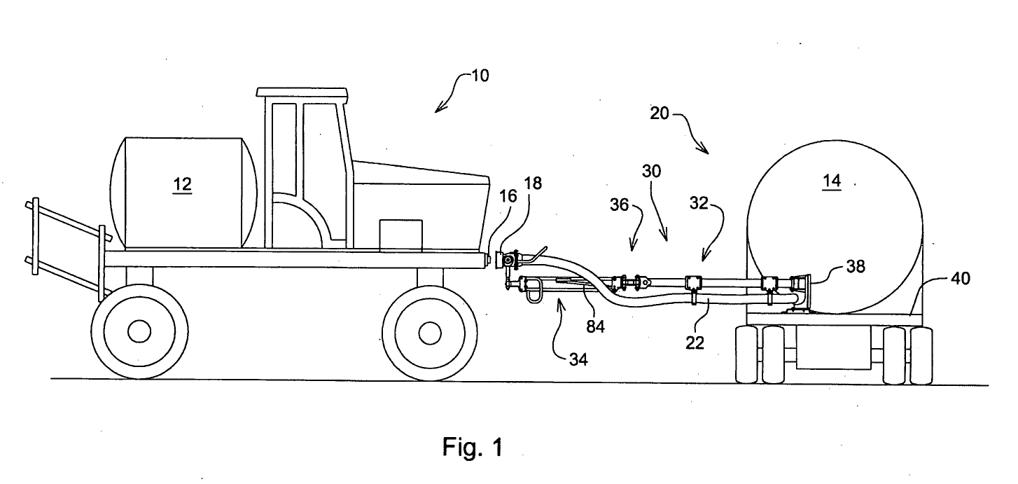

Referring now to FIG. 1, there is shown a sprayer vehicle 10 and a nurse vehicle 20 parked in close proximity to each other for permitting a tank 12 carried by the sprayer vehicle 10 to be refilled from a tank 14 carried by the nurse vehicle 20. For the purposes of this application, right and left designations are considered with respect to a viewed standing behind the nurse tank vehicle 20 having a forward direction of travel into the page as viewed in FIG. 1.

Provided for accomplishing refill of the sprayer vehicle tank 12, an intake conduit (not shown) is coupled to the sprayer vehicle tank 12 and has a forward end connected to a coupler section 16 defining an insert body adapted for being received within a receptacle defined by a coupler section 18 of the nurse vehicle, which is connected to one end of a fluid transfer conduit 22 connected to the nurse vehicle tank 14 in a manner not shown. The coupler section 18 is mounted to the outer end of an arm arrangement 30 comprising inner and outer arm sections 32 and 34, respectively, interconnected by a double hinge arrangement 36, with the inner arm section 32 having an inner end pivotally coupled to an arm support member 38 that is fixed to a bed 40 of the nurse vehicle. The fluid transfer conduit 22 has a flexible section having a length at least equal to an extended length of the arm arrangement 30 for purposes which will become apparent from the following description.

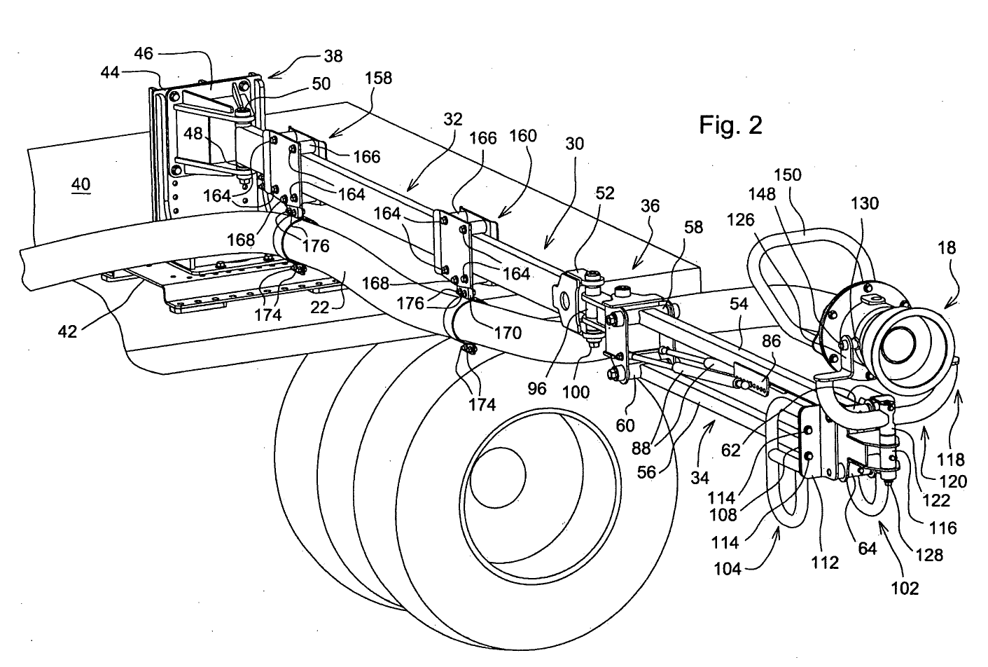

Referring now also to FIGS. 2-4, it can be seen that the arm support member 38 includes a generally horizontal base 42 including an elevated central region having opposite sides joined to vertically offset flanges which are bolted to the bed 40, with an upright post structure 44 having a mounting plate at its bottom bolted onto the elevated middle section of the base 42 and having an upper region defined by an arm mount bracket 46, which is triangular in top view and defines a clevis at its vertex. The arm support member 38 can be mounted in a variety of ways to accommodate differing nurse tank frame constructions.

The inner arm section 32 of the arm arrangement 30 comprises an elongate, rectangular tube having an upright cylindrical tube 48 welded to its inner end, the tube 48 being received in, and coupled to the arm support clevis by a pivot pin 50 which cooperates with the tube 48 to establish an upright axis about which the arm arrangement 30 may be pivoted from side-to-side. An outer end of the inner arm section 32 is defined by a clevis 52.

The outer arm section 34 of the arm arrangement comprises a parallel linkage defined by upper and lower links 54 and 56, respectively, having inner ends defined by horizontal tubes 58 and 60, and outer ends defined by horizontal tubes 60 and 62. The Inner and outer ends of the upper and lower parallel links 54 and 56 are respectively pivotally connected to inner and outer support members 64 and 66, respectively. Specifically, the inner support member 64 defines a inner vertical clevis section 68 and an outer horizontal clevis section 70, with the horizontal tubes 70 and 72 of the inner ends of the links 54 and 56 being received in, and pivotally coupled to, the vertical clevis section 70 by upper and lower pivot pins 72 and 74, respectively. The outer support member 66 includes an inner vertical clevis section 76 and an outer horizontal clevis section 78, with the horizontal tubes 62 and 64 of the outer ends of the links 54 and 56 being received within, and pivotally coupled to, the inner vertical clevis section 76 by pivot pins 80 and 82, respectively. Fixed to opposite sides of a mid-region of the upper link 54 are a pair of parallel, gas strut mounting brackets 84, with each bracket 84 containing a plurality of adjustment holes 86 spaced along its length. A pair of extensible and retractable gas struts 88 have cylinder ends respectively pivotally coupled to the brackets 84 by a fastener 90 received in a selected one of the holes 86, the struts 88 having rod ends respectively coupled to upright plates defining the vertical clevis 70 by fasteners 92 inserted through holes provided in a lower region of the clevis 70 just above the pivot pin 74. The gas struts 88 are charged and mounted for supporting a substantial portion of a combined weight of the parallel links 64 and 66, the coupler section 18 and the transfer conduit 22 that is suspended for vertical movement at the pivot bolts 72 and 74. The action of the struts 88 substantially reduce the effort an operator must exert in manually moving the coupler section 18 during the operation of refilling the planter vehicle tank 12 from the fluid supply carried by the tank 14 of the nurse vehicle 20, as described below in further detail.

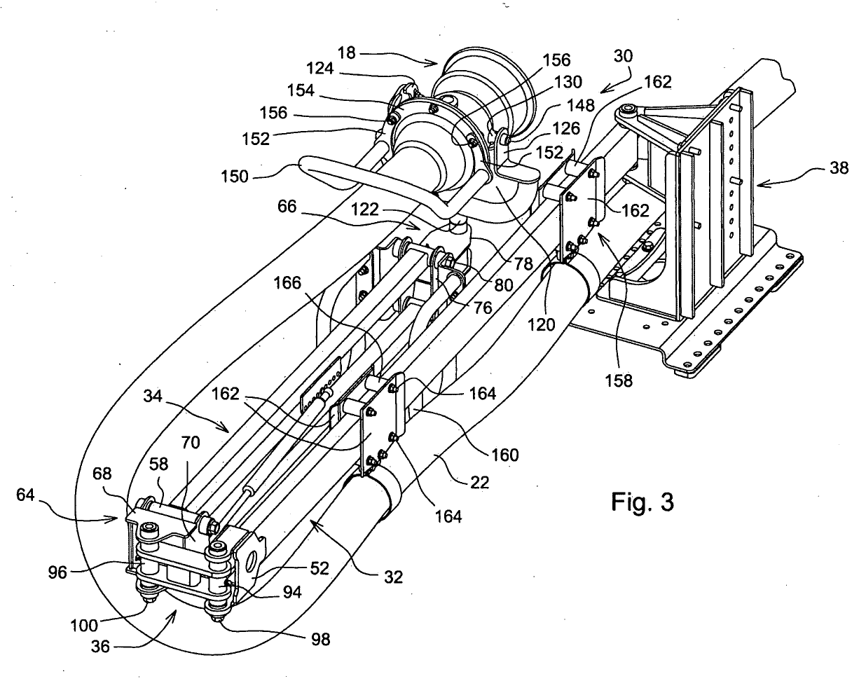

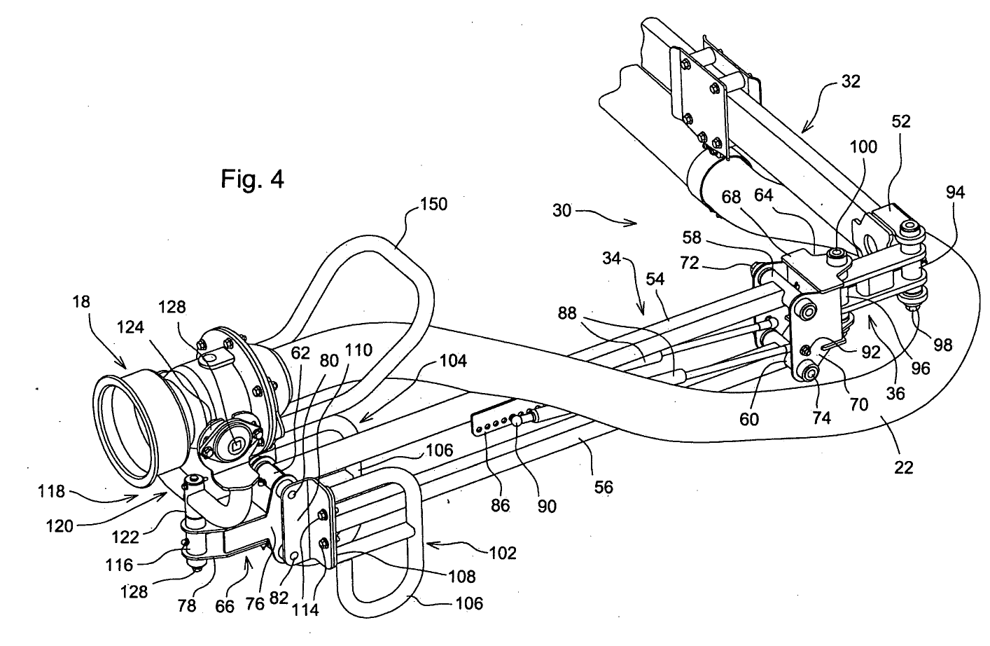

The double hinge structure 36 provided for interconnecting the outer end of the inner arm section 32 to the inner end of the outer arm section 34 and includes inner and outer ends respectively defined by inner and outer, upright tubes 94 and 96, with the inner tube 94 being received in, and coupled to the clevis 52 by a pivot pin 98, and with the outer tube 96 being received in, and coupled to the clevis 68 by a pivot pin 100. Thus, it will be appreciated that the double hinge structure 36 permits the outer arm section 34 to be swung approximately 360° at its connection with the outer end of the inner arm section 32. Handles 102 and 104 are provided at opposite sides of the outer end region of the outer arm section 34 that an operator may grasp when maneuvering the arm arrangement 30 between its folded stored position shown in FIG. 3 and its extended position shown in FIG. 2, for example. As can best be seen in FIGS. 2 and 4, the handles 102 and 104 are identical and each includes a tubular structure 106 bent to form a loop and being joined to a vertical mounting plate 108 extending at a right angle to the arm section 34. Mounted to opposite sides of the support structure 66 at the outer end of the arm section 34 are right and left support brackets 110 and 112 being right angular in form and having parallel first legs located at opposite sides of the vertical front clevis section 76 of the support structure 66 and secured thereto with the pivot pins 80 and 82. Second legs of the support brackets 110 and 112 project oppositely outwardly form the clevis section 76, with the handle mounting plates 108 respectively being secured o these second legs by mounting bolts 114.

The fluid coupler section 18 at the end of the flexible hose 22 is supported at the outer end of outer arm section 34 by the support member 66. Specifically, the outer clevis 78 of the support member 66 includes an upright, cylindrical tube 116, and mounted to the support member 66 is a coupler section swivel mounting 118 comprising a generally U-shaped member 120 having a bottom embodying a centrally located upright tube 122 and having opposite ends joined to generally upright limbs having upper ends defined by right and left, L-shaped members having respective vertical legs 124 and 126. The swivel mounting 118 is located with the upright tube 122 resting atop the upright tube 116 of the rear support member 66, with a pivot pin 128 being received in the tubes and defining an upright axis about which the swivel mounting 118 may pivot.

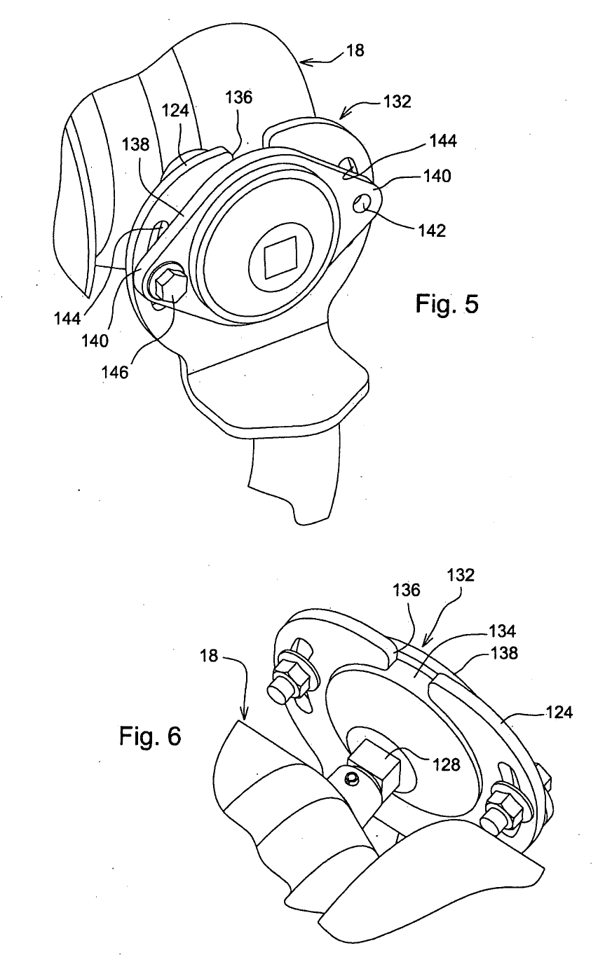

The fluid coupler section 18 is located between the vertical legs 124 and 126. Provided in axial alignment with each other, and projecting outwardly from opposite sides of a middle location of the coupler section 18, are a torsion bar 128 (FIG. 4) and a cylindrical mount 130 (FIG. 2). Referring now also to FIGS. 5 and 6, it can be seen that the torsion bar 128 is square in cross-section and is received within a similarly shaped opening in a flanged bushing 132 having a cylindrical surface 134 received in a complimentary shaped cylindrical opening provided in the vertical leg 124, with it being noted that a vertical slot 136 extends downwardly to the cylindrical opening from a top edge of the vertical leg 124 so that, prior to having the bushing mounted thereon, the torsion bar may pass vertically into the cylindrical opening during the assembly of the coupler section 18 to the swivel mounting 118. The flanged bushing 132 includes a mounting flange 138 including mounting ears 140 at its opposite sides, the ears 140 each being provided with a mounting hole 142, and the vertical leg 124 being provided with arcuate openings 144 disposed so as to remain aligned with the holes 142 so as to permit a desired amount of wind-up to be produced in the torsion bar 128 before tightening bolts 146 (only one shown) received through the aligned holes 142 and arcuate openings 144. The cylindrical mount 130 at the opposite side of the coupler section 18 is provided with a threaded axial bore which receives a threaded bolt 148 (FIGS. 2 and 3) for establishing a pivot axis about which the fluid coupler section 18 may pivot when being aligned with the fluid coupler section 16 when coupling the sections together during the refill operation. It is to be noted that the pivot axis established by the bolt 148 is located approximately at the center of mass of the fluid coupler section 18 so that the effort required to tilt the coupler section 18 alone is minimal. However, the hose 22 and fluid contained therein can result in a substantial unbalanced weight acting to tilt the fluid coupler section about the axis of the bolt 148, as viewed in FIG. 3. Thus, the torsion shaft 128 is wound-up in the clockwise direction in FIG. 3 so that it exerts a counterclockwise force tending to rotate the coupler section 18 in the counterclockwise direction.

To aid an operator in pivoting the coupler section 18 either about the upright pivot axis, defined by the bolt 128, or the transverse pivot axis, defined by the pivot pin 148, a generally U-shaped handle 150 is provided, with legs of the handle, as best shown in FIG. 3, each being provided with an in-turned end section 152 secured against a flange 154 of the coupler section 18 by a bolt 156. The flange 154 is located close to the connection of the fluid coupler section 18 to the transfer conduit 22. Thus, it will be appreciated that an operator can easily pivot the coupler section about the upright pivot axis by grasping and exerting sideways forces on the handle 150, or the operator can easily tilt the coupler section 18 about the transverse pivot axis by gripping the handle 150 and either exerting an upward or a downward force on the handle 126.

The fluid transfer conduit 22 is coupled to the inner arm section 32 by identical, inner and outer conduit hangers 158 and 160, respectively, located adjacent the support member 38, and at a location spaced from the clevis 52. The hangers 158 and 160 each include a pair of vertical plates 162 located on opposite sides of, and secured to, the inner arm section 32 by four bolts 164 arranged in a rectangular pattern, with each passing through a tubular roller 166 to allow the hangers 158 and 160 to move relative the arm section 32 as the arm arrangement 30 is moved. Located between, and at a level below, the bottom two bolts 164 in each of the hangers 158 and 160 is a fifth bolt 168 which passes through a tubular spacer (not shown) to which a rectangular mounting tab 170. Each of the hangers 158 and 160 includes a pair of strap halves 172 which together encircle the hose 22, with out-turned first ends being secured together with a set of bolts 174, and with out-turned second ends being secured together and to an associated one of the mounting tabs 170 by a set of bolts 176. These locations of the hangers 158 and 160 are chosen for minimizing resistance to the flexure of the conduit 22 during moving the arm arrangement 30 between its folded, stored position, shown in FIG. 3, and its extended position, shown in FIG. 2, without the conduit interfering with the folding of the arm arrangement 30.

In operation, assuming the fluid in the tank 12 of the sprayer vehicle 10 has become depleted so as to require a refill, the sprayer vehicle 10 will be driven to any convenient location close enough to the nurse vehicle 10 to allow for the fluid coupler section 16 carried by the sprayer vehicle 10 to be coupled to the fluid coupler section 18 carried by the nurse vehicle 14.

Once the sprayer vehicle 10 is parked, the operator will dismount and approach the arm arrangement 30 of the nurse vehicle 20, which will initially be in its folded stored position on the trailer bed 40, as shown in FIG. 3. The operator will then grab the closest handle 102, 104 and pull outwardly so that the arm arrangement 30 will become extended, as shown in FIG. 1, with the amount of extension depending on the distance between the sprayer vehicle 10 and nurse vehicle 20. Assuming that the coupler section 18 has to be raised or lowered to approximate the level of the coupler section 16, the operator will exert a lifting or lowering force on the outer arm section 34, which, due to its construction as a parallel linkage, will result in the coupler section 18 being raised or lowered as desired. If further manipulation of the coupler section 18 is required for alignment, the operator will grasp the handle 150 and exert a force tending to either swivel the coupler section 18 and swivel mount 118 about the upright axis defined by the bolt 128 or to tilt the coupler section 18 about the transverse axis defined by the pins 148. When the coupler sections 16 and 18 are properly aligned, further extension of the arm arrangement will result in the receptacle defined by the coupler section 18 being received over the insert defined by the coupler section 16. A control system (not disclosed) will then act to automatically, sequentially cause the coupler sections 16 and 18 to be locked and sealed together, a fluid transfer pump (not shown) to be controlled so as to permit substantially leak-free transfer of fluid from the nurse vehicle tank 14 to the sprayer vehicle tank 12, to interrupt the pumping action of the fluid transfer pump when the tank is full, and thereafter effect leak free disconnection of the coupler sections 16 and 18.

Having described the preferred embodiment, it will become apparent that various modifications can be made without departing from the scope of the invention as defined in the accompanying claims.

1. In a nurse vehicle including a fluid transfer conduit having a first fluid coupler section at one end adapted for being coupled in fluid transfer relationship to a mating second fluid coupler section carried by a sprayer vehicle when it is desired to transfer fluid from the nurse vehicle to the sprayer vehicle, the improvement comprising: said nurse vehicle including an arm arrangement having an inner end connected to said nurse vehicle; a connecting bracket mounting said first coupler section to an outer end of said arm arrangement; and said outer end of said arm arrangement being mounted for both transverse and up and down movements.

2. The nurse vehicle, as set forth in claim 1, wherein said connecting bracket is a swivel bracket mounted to said outer end of the arm arrangement for swiveling about an upright axis.

3. The nurse tank vehicle, as set forth in claim 1, wherein said first fluid coupler section is mounted to said connecting bracket for tilting about a transverse axis.

4. The nurse tank vehicle, as set forth in claim 2, wherein said first fluid coupler section is mounted to said connecting bracket for tilting about a transverse axis disposed in crosswise relationship to said upright axis.

5. The nurse tank vehicle, as defined in claim 1, wherein said arm arrangement includes an inner end mounted for pivoting about an inner upright pivot axis.

6. The nurse tank vehicle, as defined in claim 1, wherein said arm arrangement includes an inner arm section and an outer arm section; and a hinge joint arrangement coupling said inner and outer arm sections together for pivoting relative to each other about at least one upright hinge joint axis.

7. The nurse tank vehicle, as defined in claim 6, wherein said hinge joint arrangement defines a double hinge joint, including a second upright hinge joint axis, with said at least one upright hinge joint axis being defined between one side of said hinge joint arrangement and said inner arm section, and said second upright hinge joint axis being defined between another side of said hinge joint arrangement and said outer arm section.

8. The nurse tank vehicle, as defined in claim 6, wherein said outer arm section defines a parallel linkage oriented for up and down movement relative to said hinge joint arrangement.

9. The nurse tank vehicle, as defined in claim 8, wherein a weight balance device is coupled to said parallel linkage for counterbalancing weight exerted on said parallel linkage tending to urge the parallel linkage downward.

10. The nurse tank vehicle, as defined in claim 1, wherein said fluid transfer conduit includes a flexible conduit section having an end connected to said first fluid coupler section; and at least one conduit hanger connecting said flexible conduit section to said arm arrangement.

11. The nurse tank vehicle, as defined in claim 1 wherein a weight balance device is coupled to said arm arrangement for balancing at least a major portion of weight tending to move said outer end of the arm arrangement downwardly.

12. The nurse tank vehicle, as defined in claim 1, wherein said arm arrangement includes a parallel linkage, with said outer end of said arm arrangement being mounted to said parallel linkage.

13. The nurse tank vehicle, as defined in claim 12, and further including a weight balance device coupled to said parallel linkage so as to counterbalance weight acting to move said parallel linkage downwardly.

14. The nurse tank vehicle, as defined in claim 13, wherein said weight balance device includes at least one gas strut.

15. The nurse tank vehicle, as defined in claim 3, and further including a weight balance device mounted so as to act between said first fluid coupling section and said connecting bracket so as to counterbalance the weight of said hose and any fluid contained therein that resist tilting movement of said first coupling section about said transverse axis.

16. The nurse tank vehicle, as defined in claim 15, wherein said weight balance device is a torsion bar located along said transverse axis.
